(19) United States
(12) Patent Application Publication
(10) Pub. No.: US 2004/0168177 A1
(43) Pub. Date: Aug. 26, 2004

(54) Optical pickup device and optical information recording and/or reproducing apparatus

(75) Inventors: Tetsu Tanaka, Tokyo (JP); Takeshi Kubo, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/701,665

(22) Filed: Nov. 6, 2003

(30) Foreign Application Priority Data
Dec. 26, 2002 (JP) 2002-378504

(51) Int. Cl. G11B 7/08

(52) U.S. Cl. 720/672

(57) ABSTRACT

An optical pickup device and an optical information recording and/or reproducing apparatus which make it possible to stably secure electrical wires at predetermined locations in a slide base when forming the slide base by covering a surface of a circuit core, which functions as an electrical wiring, with an external base portion, with a portion of the circuit core being exposed. The slide base includes a circuit core and an external base portion. The circuit core is an electrical conductor forming an electrical circuit for supplying electricity to a bi-axial actuator. The external base portion is an insulating member for covering a surface of the circuit core with a portion of the circuit core being exposed. An external frame is continuously formed with the outer side of the circuit core and is cut off from the circuit core after covering the circuit core with the external base portion by injection molding. The external frame has at least two positioning holes for positioning the external frame at a die, used for the injection molding, when covering the circuit core. With the circuit core being positioned at the die by fitting at least two positioning pins disposed at the die to the at least two positioning holes of the external frame, the external base portion is molded integrally with the circuit core by the injection molding.

### BACKGROUND OF THE INVENTION

1. Field of the Invention

The present invention relates to an optical pickup device for focusing a light beam on an information recording surface of, for example, an optical disc or a magneto-optical disc, and an optical information recording and/or reproducing apparatus for recording (writing) an information signal onto and/or reproducing (reading) the information signal from the information recording surface using the optical pickup device. More particularly, the present invention relates to an optical pickup device comprising a slide base including a circuit core and an external base portion, with the circuit core being an electrical conductor that forms electrical circuits, and the external base portion being an insulating member; and an optical information recording and/or reproducing apparatus using the optical pickup device.

2. Description of the Related Art

In general, a related optical information recording/reproducing apparatus comprises a disc rotating device, an optical pickup device, and a pickup moving device. The disc rotating device rotationally drives an optical disc at a predetermined speed. The optical pickup device comprises an objective. lens drive device including an objective lens for focusing a light beam on an information recording surface of the optical disc. The pickup moving device moves the optical pickup device along the information recording surface of the optical disc. The light beam emitted from the optical pickup device is used to continuously irradiate a data recording track of the optical disc, and is reflected by the track as a returning light beam. Based on the returning light beam, data is recorded (written) onto and/or reproduced (read) from the optical disc.

An example of a related optical pickup device, used in this type of optical information recording/reproducing apparatus having a structure such as that shown in FIG. 14 is known. An optical pickup device 1 comprises a bi-axial actuator 2, a slide base 3, a flexible flat cable (hereinafter referred to as the “FF cable”) 4, and a protective cover 5 for the bi-axial actuator 2. The bi-axial actuator 2 is an objective lens drive device. The slide base 3 has the bi-axial actuator 2 mounted thereto. The FF cable has an electrical circuit for supplying electrical power to the bi-axial actuator 2.

The bi-axial actuator 2 comprises a supporter 6, a yoke 7, a pair of flexible suspension wires 8 and 8, a lens holder 9, and an objective lens 10. The supporter 6 and the yoke 7 are secured to the slide base 3. The suspension wires 8 and 8 are mounted to the supporter 6. The lens holder 9 is supported at an end of each of the suspension wires 8 and 8. The objective lens 10 is mounted to the lens holder 9. A focusing and tracking coil 11 is mounted to the lens holder 9. A pair of opposing upstanding portions 7a and 7a are formed on the yoke 7, and have respective magnets 12 mounted thereto. A magnetic circuit is formed between the magnets 12 and the coil 11.

A light path hole 3a for passing light beams is formed in the slide base 3. The bi-axial actuator 2 is mounted to the upper surface of the slide base 3 so that the objective lens 10 faces the light path hole 3a from above it. The protective cover 5 is mounted to the slide base 3 so as to cover the bi-axial actuator 2. An opening 5a for passing light beams is formed in the protective cover 5. A rectangular coupler mounting portion 3b is disposed on the lower surface of the slide base 3. A laser coupler 13 is mounted to the lower end of the coupler mounting portion 3b.

A semiconductor laser, which is a laser light source in the laser coupler 13, emits light beams. An upwardly moving light beam emitted from the semiconductor laser passes through the light path hole 3a of the slide base 3 and reaches the objective lens 10 of the bi-axial actuator 2. The objective lens 10 narrows the light beam, and an information recording surface of an optical disc is irradiated with the narrowed light beam. The light beam that has passed through the objective lens 10 is reflected by the information recording surface, returns to the objective lens 10, and passes through the objective lens 10 again, so that a photodetector in the laser coupler 13 is irradiated with the light beam. An information signal that is recorded on the information recording surface is read out using the returning light beam. At the same time a focusing error signal or tracking error signal is detected.

Electrical parts 14 for controlling driving of the bi-axial actuator 2, etc., are mounted to the FF cable 4. The FF cable 4 comprises a first connector 4a, which protrudes towards one side, and a second connector 4b, which protrudes towards the other side. The FF cable 4 is connected to an external wiring through a connector 15. An end of the first connector 4a is connected to the supporter 6 for supplying electrical power to the focusing and tracking coil 11. An end of the second connector 4b is connected to the bottom surface of the laser coupler 13 for supplying electrical power to the laser coupler 13. The FF cable 4 is mounted to a side surface of the slide base 3 through a wiring board 16.

Another example of a related optical pickup device is disclosed in, for example, Japanese Unexamined Patent Application Publication No. 2001-67718 (page 2, FIG. 2). This patent document discloses an optical pickup device whose dimensional precision can be increased and which can be reduced in weight without reducing strength. The optical pickup device irradiates a signal recording surface of an optical disc with a light beam and detects a returning light beam reflected from the signal recording surface, and has a light source and other required parts mounted to a slide base that moves in radial directions of the optical disc, with the slide base being formed by outsert molding a sheet metal portion to a synthetic resin portion. In the optical pickup device, the portion requiring dimensional precision is formed as the synthetic resin portion, and the sheet metal portion is outsert molded to the synthetic resin portion to provide the required precision. By this, the dimensional precision is increased and weight is reduced.

However, in such related optical pickup devices, the focusing and tracking coil 11 and the FF cable 4 for supplying electrical power to the laser coupler 13 are used inside the optical pickup device, and the connector 15 is used to connect an external wiring and the electrical circuit of the FF cable 4. Therefore, it is necessary to use parts for mounting the FF cable 4 and the connector 15. Consequently, not only is the number of parts increased due to the use of the mounting parts, but also the task of mounting these parts needs to be carried out, thereby increasing costs. As a result, the optical pickup device is costly.

In addition, in such related optical pickup devices, a semiconductor laser and the photodetector of, for example, the laser coupler 13 or a hologram laser unit are mounted in a package that is sealed. Therefore, costs are increased by an increase in the number of man-hours required due to the necessity of adjusting the laser coupler 13 during mounting, as well as by the mounting of the parts in the package that is sealed.

### SUMMARY OF THE INVENTION

Accordingly, in view of the related problems mentioned above, the present invention make it possible to stably secure an electrical wiring to a predetermined location in a slide base when forming the slide base by covering substantially the entire circuit core, which functions as an electrical wiring, with an external base portion. It is a first object of the present invention to provide an optical pickup device which, by mounting a semiconductor laser, a photodetector, and other electronic parts to the slide base, makes it possible to use an FF cable less frequently as possible and to reduce size and costs, and to increase the precision with which the circuit core is positioned with respect to the external base portion, to increase yield when performing injection molding, and to increase the ease with which the optical pickup device is assembled. It is a second object of the present invention to provide an optical information recording and/or reproducing apparatus using the optical pickup device.

To the first end, according to a first aspect of the present invention, there is provided an optical pickup device comprising an objective lens drive device and a slide base. The objective lens drive device includes an objective lens opposing an information recording surface of a disc-shaped recording medium. The slide base is used for mounting an optical device for irradiating the information recording surface with a light beam in order to read and/or write an information signal, and moves substantially parallel to the information recording surface. The slide base comprises a circuit core and an external base portion. The circuit core is an electrical conductor forming an electrical circuit for supplying electricity to the objective lens drive device. The external base portion is an insulating member for covering a surface of the circuit core with a portion of the circuit core being exposed. An external frame is continuously formed with the outer side of the circuit core and is cut off from the circuit core after covering the circuit core with the external base portion by injection molding. The external frame has at least two positioning holes for positioning the circuit core and the external frame at a die, used for the injection molding, when covering the circuit core. With the circuit core and the external frame being positioned at the die by fitting at least two positioning pins disposed at the die to the at least two positioning holes of the external frame, the external base portion is molded integrally with the circuit core by the injection molding.

The optical pickup device of the application may have a structure in which, during the injection molding, the circuit core includes, as an electrical circuit, a connecting portion that is not required and a connecting portion that needs to be separated; the external base portion has an opening for exposing the connecting portions; and the connecting portions are cut using the opening after the injection molding.

The optical pickup device of the application may have a structure in which the opening is formed by a supporting pin disposed at the die and used to support the connecting portions.

The optical pickup device of the application may have a structure in which the circuit core comprises a step in the height direction for allowing electronic parts to be mounted at different heights.

To the second end, according to a second aspect of the present invention, there is provided an optical information recording and/or reproducing apparatus comprising a disc rotating device for rotationally driving a disc-shaped recording medium; and an optical pickup device for recording an information signal onto and/or reproducing the information signal from an information recording surface of the disc-shaped recording medium. The optical pickup device comprises an objective lens drive device including an objective lens opposing the information recording surface; and a slide base for mounting an optical device for irradiating the information recording surface with a light beam in order to read and/or write an information signal. The slide base moves substantially parallel to the information recording surface, and comprises a circuit core and an external base portion. The circuit core is an electrical conductor forming an electrical circuit for supplying electricity to the objective lens drive device. The external base portion is an insulating member for covering a surface of the circuit core with a portion of the circuit core being exposed. An external frame is continuously formed with the outer side of the circuit core and is cut off from the circuit core after covering the circuit core with the external base portion by injection molding. The external frame has at least two positioning holes for positioning the external frame at a die, used for the injection molding, when covering the circuit core. With the circuit core and the external frame being positioned at the die by fitting at least two positioning pins disposed at the die to the at least two positioning holes of the external frame, the external base portion is molded integrally with the circuit core by the injection molding.

By virtue of the above-described structure, in the optical pickup device of the application, it is possible to position the circuit core in the die by fitting the at least two positioning pins, disposed at the die, into the at least two positioning holes of the external frame, so that, with the circuit core being positioned, the external base portion is insert-molded and formed integrally with the circuit core. By this, it is possible to prevent positional displacement and flexing of the circuit core caused by, for example, the flow of synthetic resin, so that the electrical circuit wiring can be stably secured to he predetermined position in the slide base. In addition, since the circuit core functioning as an electrical wiring is integrally formed with the external base portion, it is possible to reduce the number of and the frequency of use of wiring parts, such as an FF cable and a connector, are used, so that the number of man-hours required for the mounting operation and costs can be reduced.

In the optical pickup device of the application, even if the circuit core, as an electrical circuit, has an undesirable connecting portion and a connecting portion that needs to be separated, by cutting the connecting portions using the opening of the external base portion after injection molding of the external base portion, it is possible to prevent partial deformation of the circuit core occurring when the injection molding is carried out, so that a fine wiring shape in the slide base can be maintained in a predetermined shape.

In the optical pickup device of the application, by forming the opening of the external base portion with a supporting pin that is disposed at the die for supporting the connecting portions of the circuit core, it is possible to prevent the structure of the die from becoming complicated.

In the optical pickup device of the application, since a step is formed in the circuit core in the height direction, it is possible to three-dimensionally mount desired electronic parts at different heights due to the step.

In the optical information recording and/or reproducing apparatus of the application, the slide base of the optical pickup device includes a circuit core, an external base portion, and an external frame. The circuit core is positioned in the die by fitting the at least two positioning pins at the die to the at least two positioning holes of the external frame. With the circuit core being positioned, the external base portion is insert-molded and formed integrally with the circuit core. Therefore, with an electrical wiring function being provided in the slide base, it is possible to form an optical information recording and/or reproducing apparatus using a slide base that is reduced in size and cost, so that the size and weight of the entire optical information recording and/or reproducing apparatus can be reduced.

### BRIEF DESCRIPTION OF THE DRAWINGS

FIG. 1 is a perspective view of an optical pickup device of an embodiment of the present invention;

FIG. 2 is an exploded perspective view of the optical pickup device of the embodiment of the present invention;

FIG. 3 is a perspective view of the main portion of the back surface of the optical pickup device of the embodiment of the present invention;

FIG. 4 shows an optical system of the optical pickup device of the embodiment of the present invention;

FIG. 5 is a plan view of a circuit core and an external frame of the optical pickup device of the embodiment of the present invention;

FIG. 6 is a plan view showing a state in which an external base portion is injection molded to the circuit core having the external frame shown in FIG. 5 integrally formed therewith;

FIG. 7 is a perspective view of an example of a die (lower die) having a structure that corresponds to that of the circuit core having the external frame shown in FIG. 5 integrally formed therewith;

FIG. 8 is a perspective showing a state in which the circuit core having the external frame integrally formed therewith is mounted to the die shown in FIG. 7;

FIG. 9 is an enlarged perspective view of the main portion of FIG. 8;

FIG. 10 is sectional view of the main portion of the die when carrying out injection molding of the slide base of the optical pickup device of the embodiment of the present invention;

FIG. 11 is a sectional view of a different portion of the die when carrying out the injection molding of the slide base of the optical pickup device of the embodiment of the present invention;

FIG. 12 is an external perspective view showing the general structure of an optical information recording and/or reproducing apparatus of an embodiment of the present invention using the optical pickup device shown in FIG. 1;

FIG. 13 is a block diagram of the general structure of the optical information recording and/or reproducing apparatus of the embodiment of the present invention; and

FIG. 14 is an exploded perspective view of the general structure of a related optical pickup device.

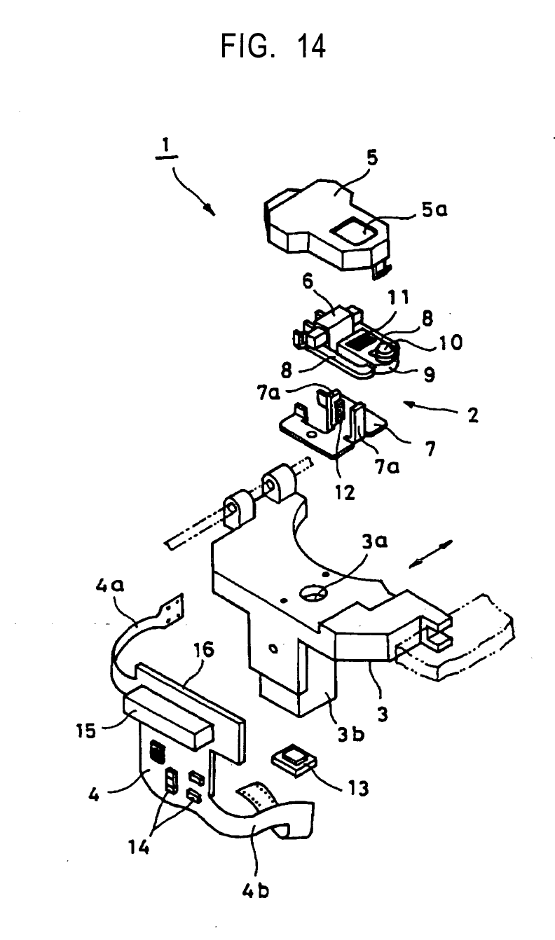

### DESCRIPTION OF THE PREFERRED EMBODIMENTS

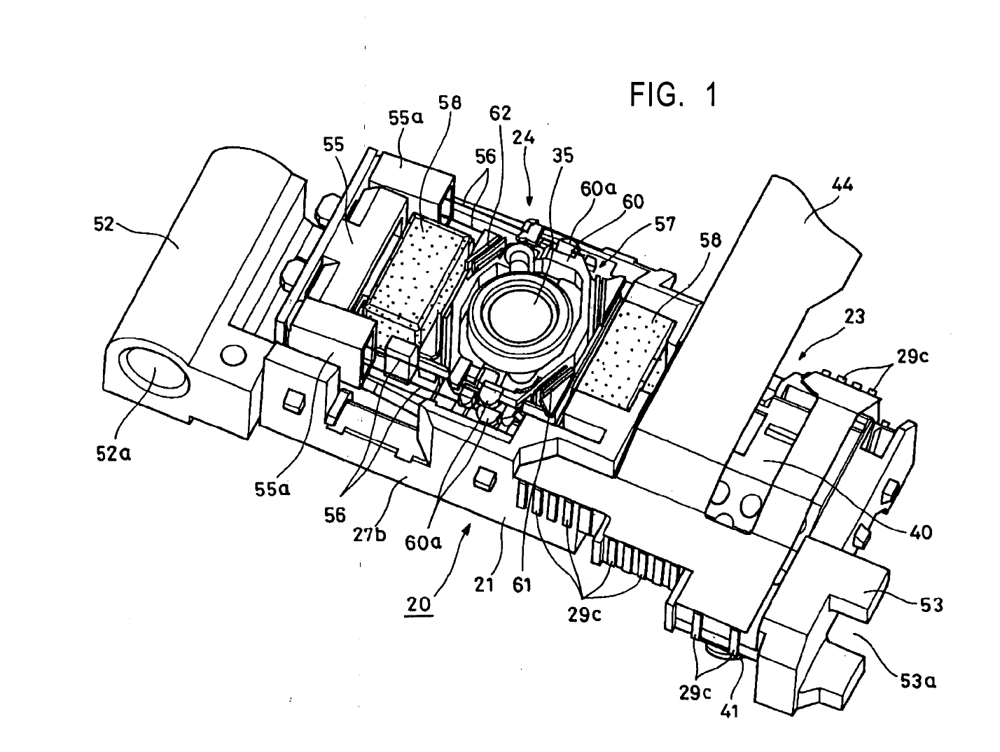

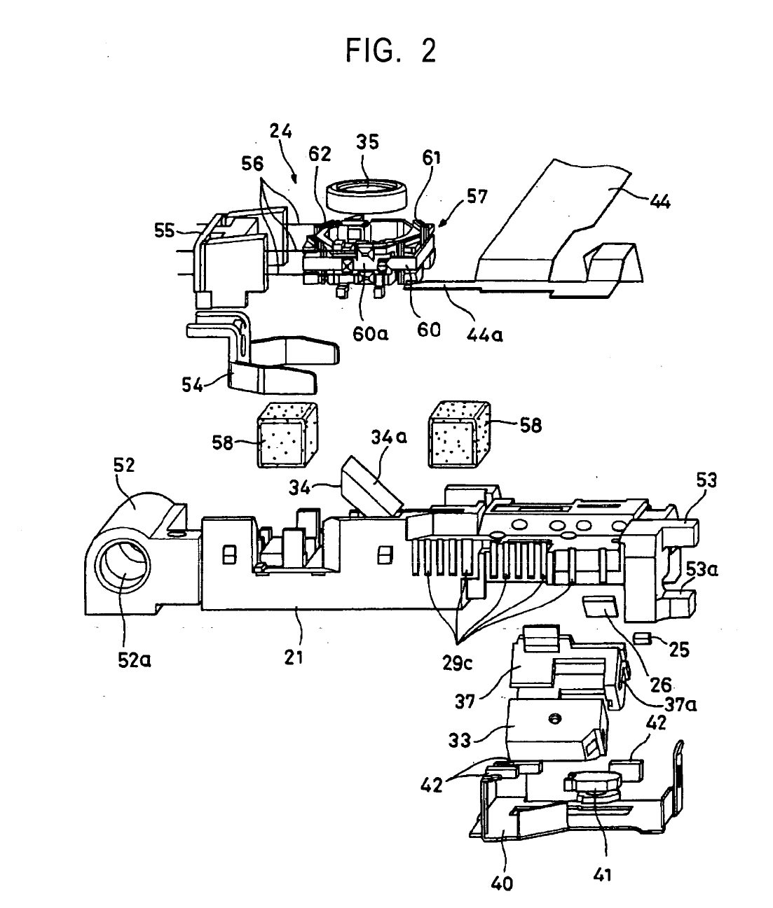

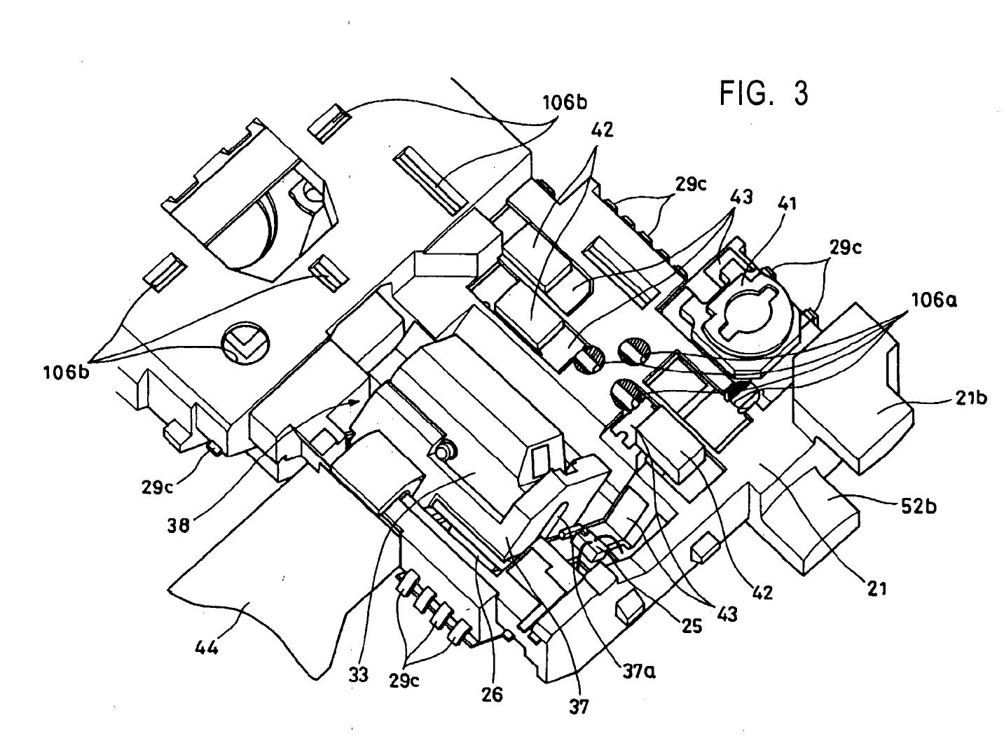

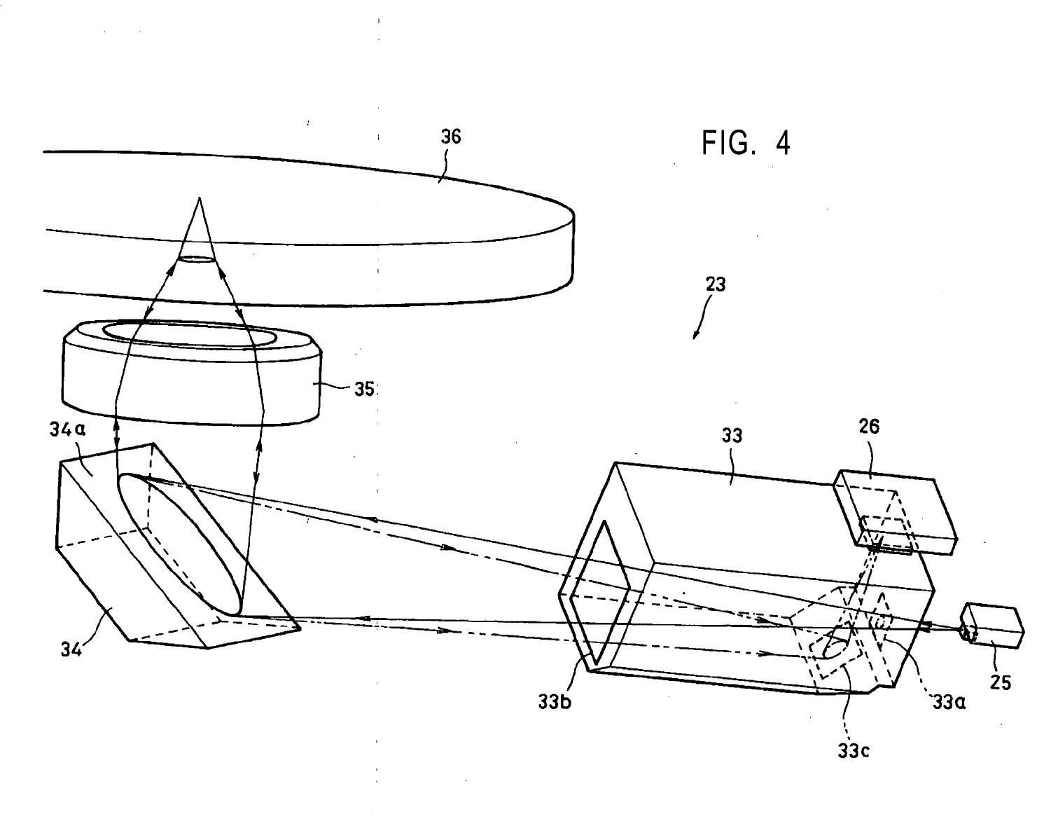

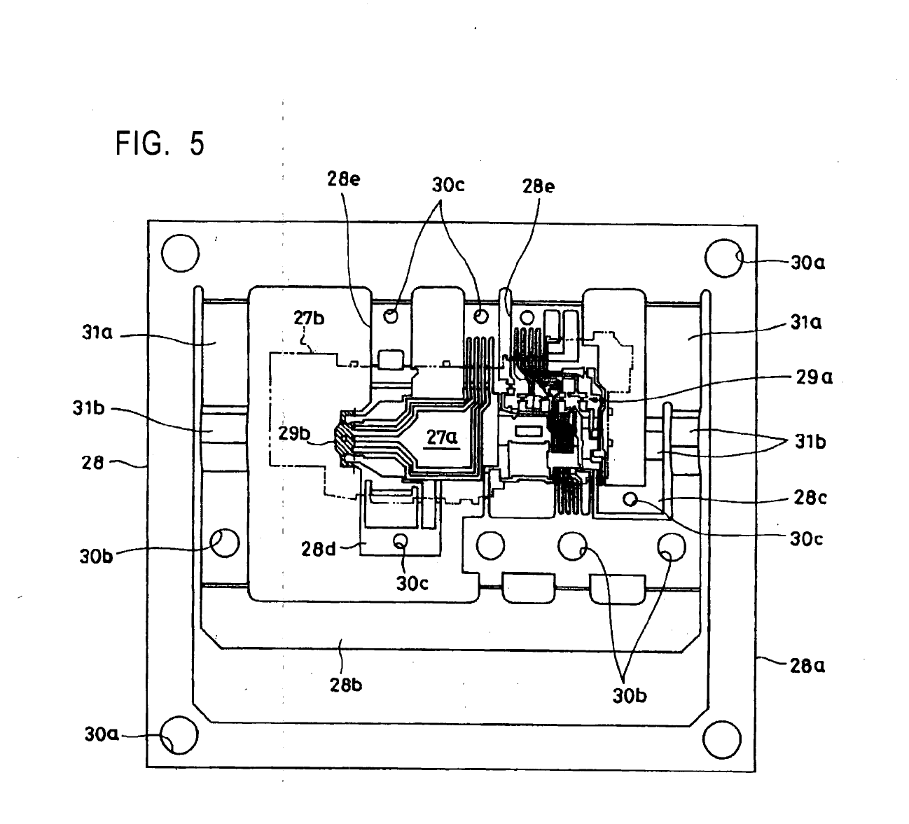

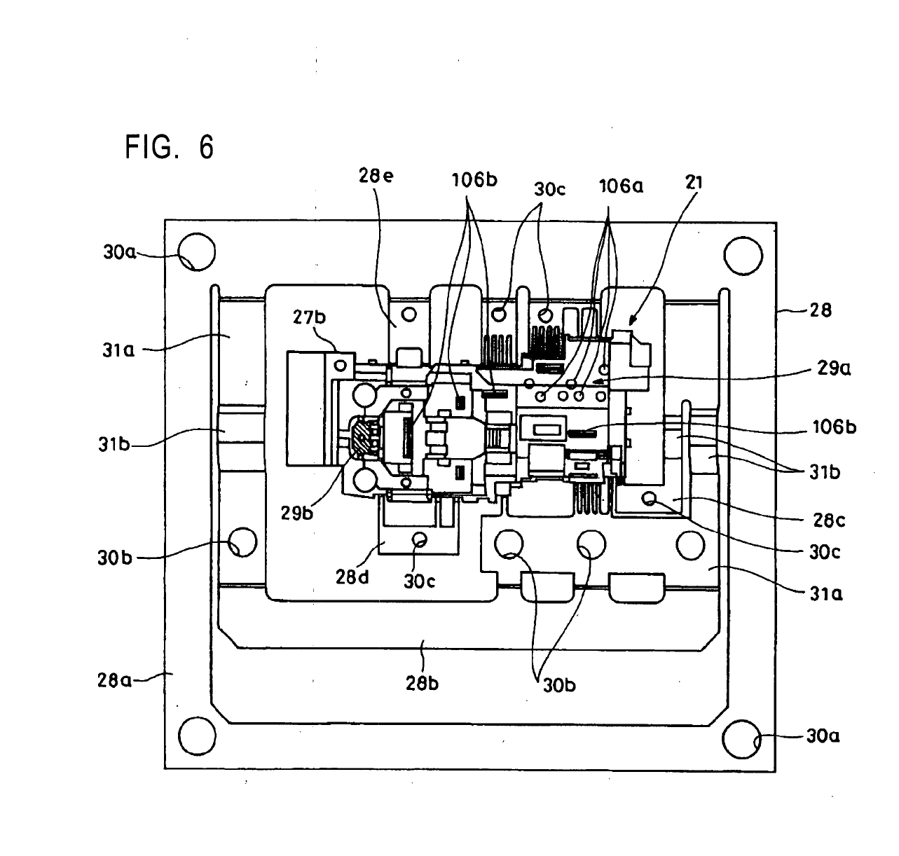

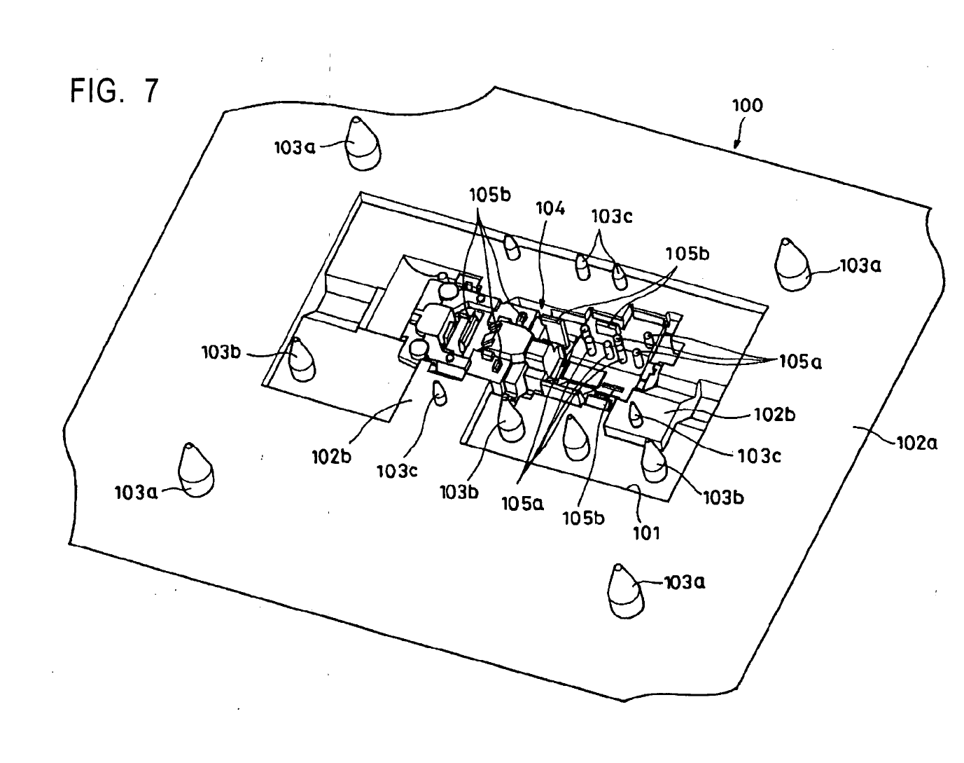

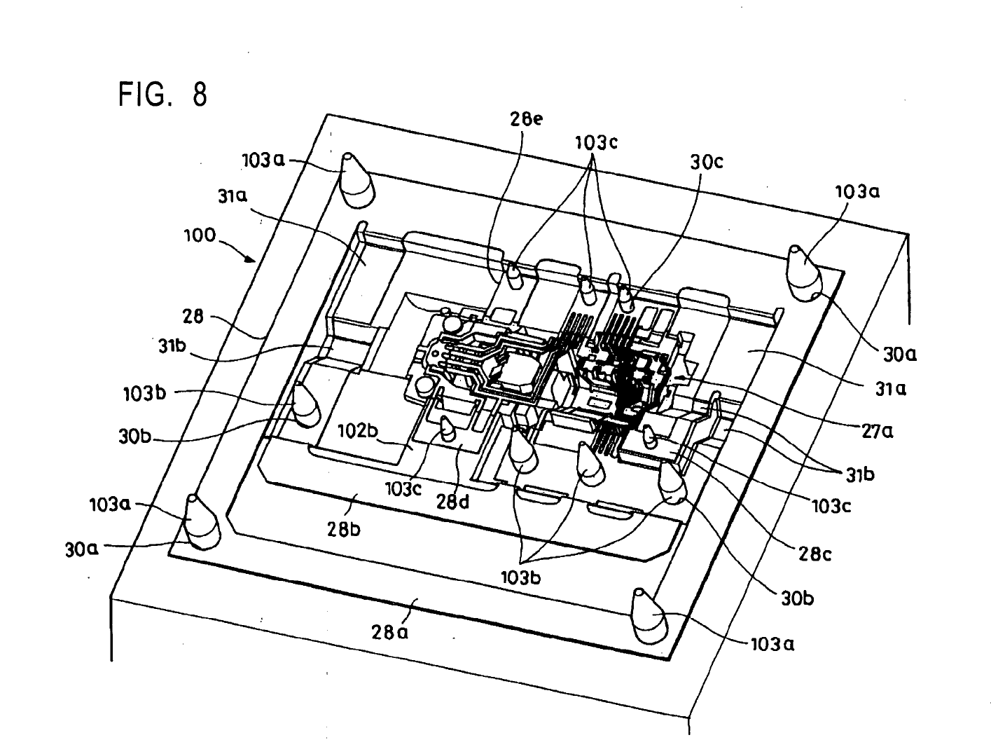

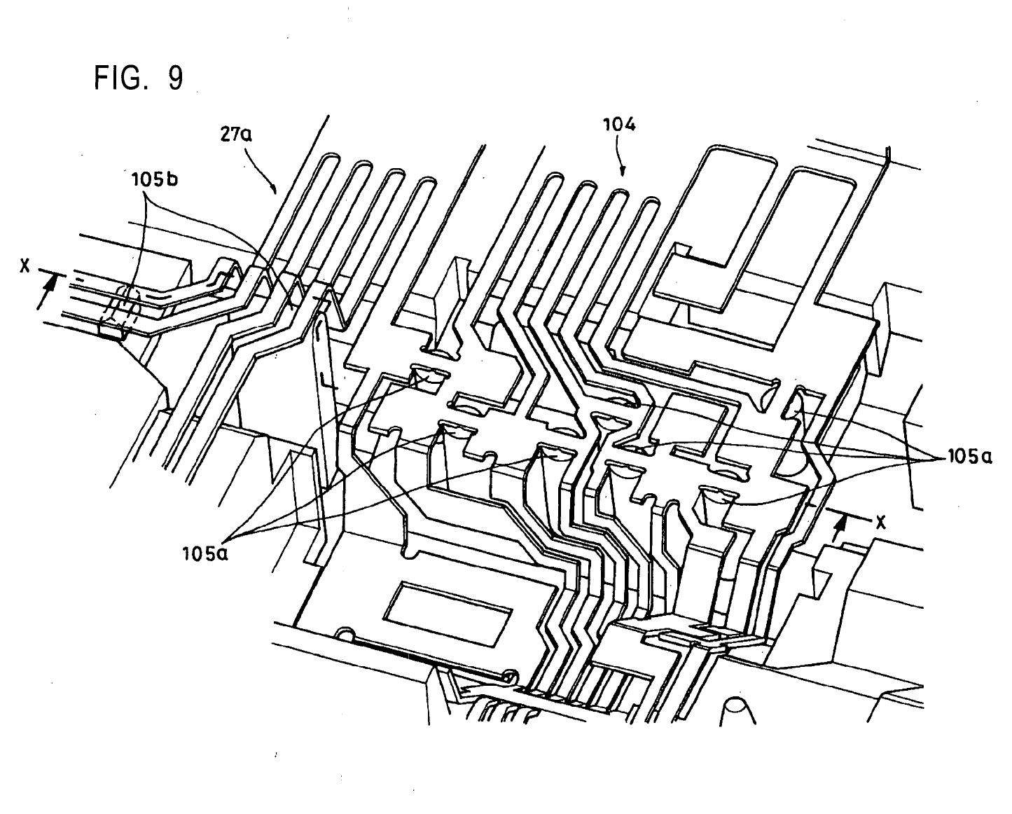

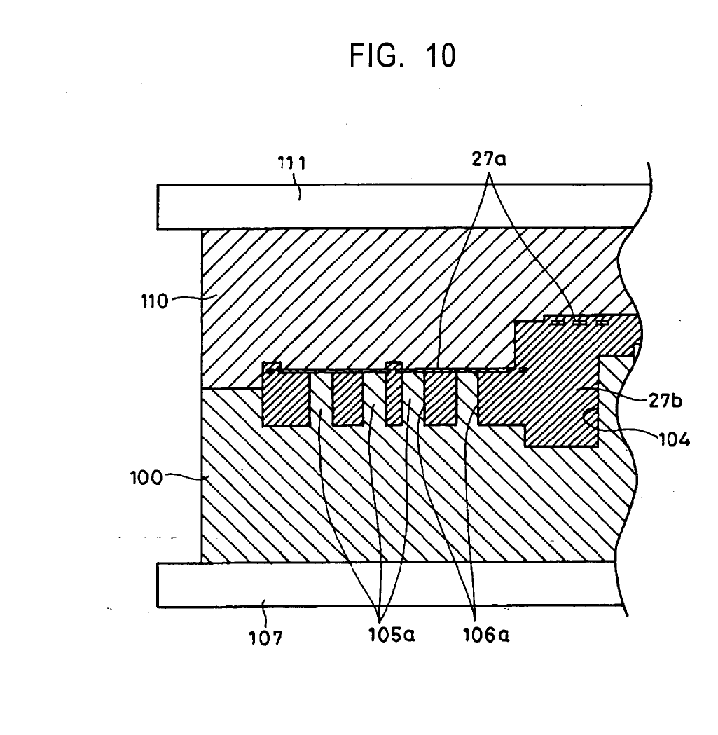

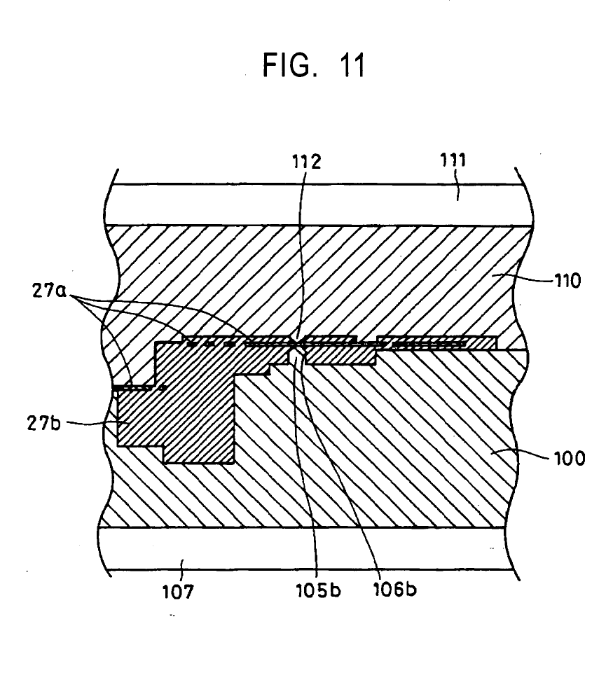

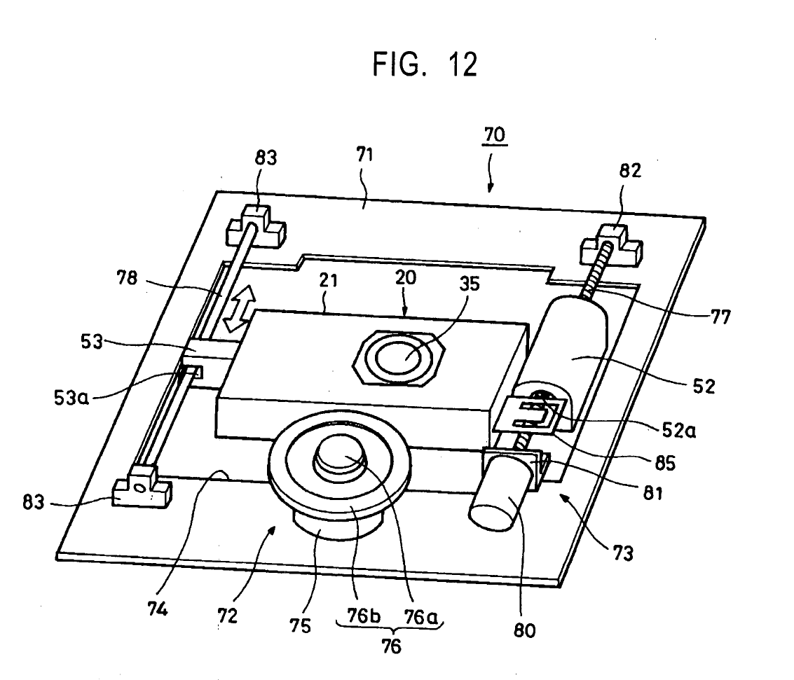

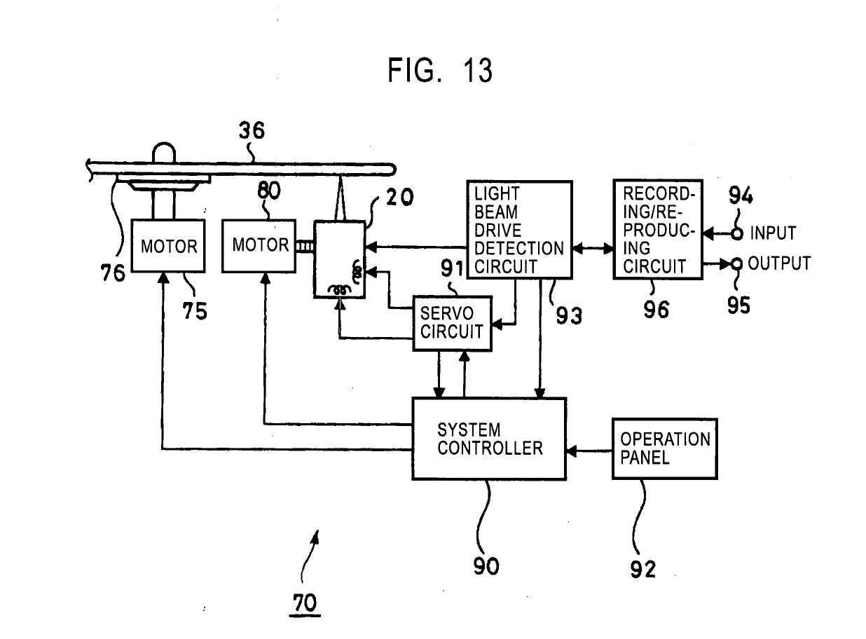

Hereunder, a description of embodiments of the present invention will be given with reference to the relevant attached drawings. FIGS. 1 to 13 show the embodiments of the present invention. FIG. 1 is a perspective view of an optical pickup device of an embodiment of the present invention. FIG. 2 is an exploded perspective view of the optical pickup device. FIG. 3 is a perspective view of the main portion of the back surface of the optical pickup device. FIG. 4 shows an optical system. FIG. 5 is a plan view of a circuit core and an external frame. FIG. 6 is a plan view showing a state in which an external base portion is integrally formed with the circuit core. FIG. 7 is a perspective view of an example of a die (lower die) having a structure that corresponds to that of the circuit core, etc., shown in FIG. 5. FIG. 8 is a perspective showing a state in which the circuit core, etc., shown in FIG. 5, are mounted to the die shown in FIG. 7. FIG. 9 is an enlarged perspective view of the main portion of FIG. 8. FIG. 10 is sectional view of the main portion of the die when carrying out injection molding. FIG. 11 is a sectional view of a different portion of the die. FIG. 12 is a perspective view of an optical information recording and/or reproducing apparatus of an embodiment of the present invention using the optical pickup device shown in FIG. 1. FIG. 13 is a block diagram of the general structure of the optical information recording and/or reproducing apparatus.

As shown in FIGS. 1 to 3, an optical pickup device 20, which is a first preferred embodiment of the present invention, comprises a slide base 21, a bi-axial actuator 24, a laser light source 25, and a photodetector 26. The slide base 21 is formed by covering a circuit core 27a with an external base portion 27b. The circuit core 27a is formed of an electrically conductive plate material. The external base portion 27b is formed of an insulating resinous material. The bi-axial actuator 24 is one specific example of an objective lens drive device mounted to the slide base 21. The laser light source 25 emits light beams for recording and/or reproducing information signals. The photodetector 26 receives light beams emitted from the laser light source 25 and reflected as returning light beams from an information recording surface of an optical disc.

As shown in FIGS. 1 and 2, the slide base 21 has a substantially rectangular shape in plan view, and has a main bearing 52 at one side in the longitudinal direction, and an auxiliary bearing 53 at the other side in the longitudinal direction. The slide base 21 is formed into an integral structure by the circuit core 27a and the external base portion 27b. By forming an electrically conductive metallic plate (such as a thin copper plate) into a predetermined wiring shape, the circuit core 27a forms electrical circuits. Required portions of the front and back surfaces of the circuit core 27a are exposed, and the other portions are covered by the external base portion 27b, formed of an insulating material. A nonmagnetic resinous material (such as liquid crystal polymer), a metal that is not magnetic, or a ceramic material may be used as the material of the external base portion 27b.

The slide base 21 is fabricated by using the circuit core 27a as an aggregate and mounting the external base portion 27b to the circuit core 27a. For example, it is possible to, after setting the circuit core 27a in a die, fill a cavity in the die with a resinous material of the external base portion 27b and integrally form the external base portion 27b with the circuit core 27a by injection molding. Therefore, as shown in FIG. 5, the circuit core 27a is formed integrally with an external frame 28 surrounding the outer side of the circuit core 27a and is supported by the external frame 28 from the sides.

The external frame 28 is used to secure and position the circuit core 27a at a predetermined position of the die (described later). The external frame 28 comprises an outer frame portion 28a, an inner frame portion 28b, a first reinforcing portion 28c, and a second reinforcing portion 28d. The outer frame portion 28a is a square frame portion. The inner frame portion 28b is disposed at the inner side of the outer frame portion 28a. The first reinforcing portion 28c is connected to one or both of the outer frame portion 28a and inner frame portion 28b. The second reinforcing portion 28d is formed separately from the outer frame portion 28a and inner frame portion 28b. The inner frame portion 28b has a substantially U shape in plan view. Both end portions of the inner frame portion 28b at the open side are continuously formed with the inner edge of one side of the outer frame portion 28a. The first reinforcing portion 28c is continuously formed with the inner edge of one side of the inner frame portion 28b, and the second reinforcing portion 28d is separately disposed at a predetermined interval from the first reinforcing portion 28c.

The circuit core 27a is disposed at the inner side of the outer frame portion 28a, the inner frame portion 28b, the first reinforcing portion 28c, and the second reinforcing portion 28d, and is continuously formed therewith by a plurality of connecting portions extending from them. The circuit core 27a comprises an aggregate of circuits having a plurality of wires (including spaces for mounting electronic devices and heat dissipation space) formed into a predetermined shape. The circuit aggregate includes, as electrical circuits, a connecting portion 29a (which is a portion that requires cutting) that should not be connected and a connecting portion 29b that should be separated from predetermined electrical circuits by cutting it afterwards. These connecting portions 29a and 29b are provided to prevent the wires from being flexed and bent by injection pressure of melted material of the external base portion 27b at the time of injection molding. After the injection molding of the external base portion 27b, the connecting portion 29a and the connecting portion 29b of the electrical circuits, are cut and separated with, for example, a cutter, respectively.

The external frame 28 has a plurality of positioning holes for positioning it at and securing it to a predetermined location of the die. In the embodiment, the external frame 28 has three types of positioning holes, first positioning holes 30a, second positioning holes 30b, and third positioning holes 30c with different diameters according to the purposes for which they are used. The first positioning holes 30a, which have the largest diameters, are used to position the entire external frame 28, and are formed at the four corners of the external frame portion 28a. The second positioning holes 30b, which have intermediate diameters, are used to position the inner frame portion 28b, and are formed at four suitable locations of the inner frame portion 28b. The third positioning holes 30c, which have the smallest diameters, are used to position protrusions 28e protruding inward from one of the sides of the first reinforcing portion 28c, the second reinforcing portion 28d, and the outer frame portion 28a. Each of the reinforcing portions 28c and 28d has one third positioning hole 30c at a substantially central portion thereof, and each of the protrusions 28e has a third positioning hole 30c formed at a base portion thereof.

As shown in FIG. 6, a plurality of steps, first steps 31a and second steps 31b, which have suitable heights, are disposed at the inner frame portion 28b, the protrusions 28e, and the circuit core 27a. Each first step 31a is used to set a reference surface of the circuit core 27a with respect to the die. Each second step 31b is used to set a predetermined portion of the circuit core 27a at a predetermined height. Each second step 31b has a step portion that extends upward from the reference surface and a step portion that extends downward from the reference surface.

An example of a suitable die (lower die) for the circuit core 27a and the external frame 28 having the above-described structure is shown in FIG. 7. In FIG. 7, a substantially square recess 101 having a size that corresponds to the size of the inner frame portion 28b of the external frame 28 is formed in a substantially central portion of a mating surface 102a of a lower die 100. Four first positioning pins 103a are disposed on the mating surface 102a so as to surround the recess 101. The four first positioning holes 30a of the outer frame portion 28a of the external frame 28 are fitted to the respective first positioning pins 103a. Four second positioning pins 103b are disposed in the recess 101. The four second positioning holes 30b of the inner frame portion 28b of the external frame 28 are fitted to the respective second positioning pins 103b.

Five third positioning pins 103c corresponding to the five third positioning holes 30c of the external frame 28 are disposed on the mating surface 102a of the lower die 100. Three of the five third positioning pins 103c are disposed in a standing manner in the recess 101, while the remaining two positioning pins 103c are disposed in a standing manner on two supporting surfaces 102b and 102b at the same height as the mating surface 102a. A cavity 104 for molding the external shape of the external base portion 27b, which is mounted to the circuit core 27a, is formed in a substantially central portion in the recess 101.

Seven supporting pins 105a and six supporting ribs 105b are disposed in the cavity 104 of the lower die 100. The seven supporting pins 105a support predetermined portions of the circuit core 27a at substantially points. The supporting ribs 105b similarly support predetermined portions of the circuit core 27a substantially along lines. The seven supporting pins 105a, which, as shown in FIG. 10, support the predetermined portions of the circuit core 27a, have the role of preventing flexing and deformation of portions of the electrical circuits caused by material injection pressure during the injection molding. Similarly, the six supporting ribs 105b, which, as shown in FIG. 11, support the predetermined portions of the circuit core 27a, have the role of preventing flexing and deformation of portions of the electrical circuits caused by the material injection pressure during the injection molding.

FIG. 8 shows a state in which the external frame 28 holding the circuit core 27a is mounted to the lower die 100 having the above-described structure. In this case, the four first positioning holes 30a of the external frame 28 are fitted to the four first positioning pins 103a at the lower die 100. Similarly, the four second positioning holes 30b are fitted to the four second positioning pins 103b. In addition, the five third positioning holes 30c are fitted to the five third positioning pins 103c. By this, the circuit core 27a is positioned at a predetermined location of the cavity 104 of the lower die 100 through the external frame 28, and is supported by the supporting pins 105a and the supporting ribs 105b.

By using the lower die 100, to which the circuit core 27a, etc., are mounted, and an upper die 110, which forms a pair with the lower die 100, in an injection molding machine (not shown), as shown in FIG. 6, it is possible to fabricate the slide base 21 having the external base portion 27b integrally formed with the circuit core 27a. FIGS. 10 and 11 are sectional views of the main portion of the lower die 100 upon which the upper die 110 is superimposed when injection molding the slide base 21.

In FIGS. 10 and 11, the upper die 110 is combined with the lower die 100. By abutting the mating surfaces of the upper and lower dies 110 and 100, a cavity for forming the external base portion 27b, which is mounted to the circuit core 27a, is formed. FIG. 10 shows a state in which the circuit core 27a in the cavity is sandwiched by the supporting pins 105a, disposed at the lower die 100, and the inner surface of the upper die 110. FIG. 11 shows a state in which the circuit core 27a is sandwiched by the supporting ribs 105b, disposed at the lower die 100, and supporting ribs 111, disposed at the upper die 100 in correspondence with the supporting ribs 105b. The melted material of the external base portion 27b is injected with a suitable pressure into portions of the cavity excluding the portions where the circuit core 27a is disposed.

In this way, by supporting the circuit core 27a with the supporting pins 105a or by sandwiching and supporting the circuit core 27a from both sides with the supporting protrusions 105b and the supporting ribs 111, it is possible to reliably prevent flexing and deformation of the circuit core 27a caused by pressure that is produced when the material of the external base portion 27b is injected. After the injection molding, the external base portion 27b has seven first openings 106a, formed as a result of removing the supporting pins 105a, and six second openings 106b, formed as a result of removing the supporting ribs 105b.

The supporting pins 105a and the supporting ribs 105b have a common function of forming openings. After the molding, the first openings 106a, formed by the seven supporting pins 105a, are used for cutting exposed electrical circuit portions. After the injection molding, a cutting tool, such as a cutter or a chisel, is inserted into the first openings 106a to cut the connecting portion 29a. Similarly, the cutting portion 29b is cut with the cutting tool, so that a previously connected superfluous portion is cut to separate the connecting portion 29b from the circuit core 27a. By this, it is possible to form predetermined electrical circuits by cutting a portion of the circuit core 27a that is superfluous as electrical circuits.

As shown in FIGS. 1 and 2, of the portions of the circuit core 27a, a plurality of required protrusions that protrude from side surfaces of the external base portion 27b form terminals 29c for connection to an external wiring. As shown in FIG. 10, portions of the circuit core 27a with which a surface of the die comes into direct contact are exposed surfaces of the electrical circuits formed by the circuit core 27a. It is possible to directly mount electronic parts, such as a semiconductor laser, a capacitor, or a resistor, to the exposed surfaces.

The lower die 100 and the upper die 110 are similar to a general die in that, for example, they are formed of materials having good thermal conductivity and provide a path for cooling water. The lower die 100 is mounted to the injection molding machine by being secured to a lower die mounting plate 107, and the upper die 110 is mounted to the injection molding machine by being secured to an upper die mounting plate 112.

As shown in FIGS. 1 and 2, the slide base 21 that is molded in this way is formed of a flat plate-shaped material that is long in one direction. The slide base 21 has the main bearing 52 at one end in the longitudinal direction, and the auxiliary bearing 53 at the other end in the longitudinal direction. The main bearing 52 has a hole 52a that passes therethrough in a direction perpendicular to the longitudinal direction, and the auxiliary bearing 53 has a groove 53a that opens at one side. The slide base 21 is formed by covering substantially the entire circuit core 27a with the external base portion 27b, formed of an insulating material, with portions of the circuit core 27a being exposed.

Next, a simple description of the process of molding the slide base 21 having the above-described structure will be given. First, as shown in FIG. 5, the circuit core 27a and the external frame 28 are integrally formed by, for example, pressing a thin plate that is formed of a metal, such as copper, having good conductivity and that can be easily processed. At this time, a predetermined number of the first to third positioning holes 30a to 30c are formed in the external frame 28, and the steps 31a and steps 31b are formed at predetermined portions of the inner frame portion 28b and the circuit core 27a in the height direction.

Next, as shown in FIG. 8, the external frame 28, etc., are set at predetermined locations of the lower die 100. The four first positioning holes 30a of the outer frame portion 28a are fitted to the first positioning pins 103a at the lower die 100, and the four second positioning holes 30b of the inner frame portion 28b are fitted to the four second positioning pins 103b. In addition, the five third positioning holes 30c in the reinforcing portions 28c, 28d, and protrusions 28e are fitted to the five third positioning pins 103c. By this, as shown in FIG. 9, the circuit core 27a is set by being supported at a predetermined position with the supporting pins 105a and the supporting ribs 105b.

Next, the lower die 100 and the upper die 110 in which the circuit core 27a is set is set in an injection molding machine in order to inject a melted resinous material of the external base portion 27b into the cavity 104 of the die. By solidifying the resinous material, as shown in FIG. 6, substantially the entire circuit core 27a excluding predetermined surface portions is covered with the external resinous base portion 27b, with the main bearing 52 and the auxiliary bearing 53, both of which are formed of resin, being formed at respective ends of the external base portion 27b in the longitudinal direction. Then, after removing the molded product from the die, a cutter is inserted into the first openings 106a of the external base portion 27b to cut the connecting portion 29a and the connecting portion 29b. By this, the slide base 21 having substantially the entire electrically conductive circuit core 27a, excluding particular portions, covered with the insulating external base portion 27b is formed.

A punching operation carried out by the aforementioned pressing operation is not the only means for forming the circuit core 27a and the external frame 28. Various other means, such as ultrasonic processing, laser processing, and etching, may be carried out.

An optical device 23 for sending and receiving information signals using laser beams and the bi-axial actuator 24, which is a specific example of an objective lens drive device, are mounted to the slide base 21, which is a specific example of a slide member that is fabricated in the above-described way. As shown in FIG. 4, the optical device 23 comprises the laser light source 25, the photodetector 26, a prism 33, a raised mirror 34, and an objective lens 35. The laser light source 25 emits a light beam for recording and/or reproducing an information signal, and may be, for example, a semiconductor laser (laser diode).

The photodetector 26 receives a light beam emitted from the laser light source 25 and reflected as a returning light beam from an information recording surface of an optical disc 36, and reads a focusing error signal and a tracking error signal. The photodetector 26 may be, for example, a photodiode IC. As shown in FIG. 3, the photodetector 26 and the laser light source 25 are mounted to the portions of electrical circuits that are exposed at a surface defining a recess 38 in the lower surface of the slide base 21. A step having a predetermined height is disposed at the recess 38. The laser light source 25 is disposed at one surface of the step, and the photodetector 26 is disposed at the other surface of the step.

The optical axis of a light beam emitted from the laser light source 25 is set horizontally. The photodetector 26 is disposed so that a light receiver is oriented in a direction perpendicular to the horizontal direction. The laser light source 25 and the photodetector 26 are electrically connected to the circuit core 27a by a plurality of wire bondings. The circuit core 27a is formed into predetermined electrical circuits by previously being cut into a predetermined pattern. Electrical power is supplied to the laser light source 25, the photodetector 26, and other electronic parts and the bi-axial actuator 24 (described below) through the circuit core 27a.

A light beam emitted from the laser light source 25 is transmitted forwardly from the laser light source 25. The prism 33 is disposed forwardly of the laser light source 25 for reflecting a returning light beam and guiding it to the photodetector 26. As shown in FIG. 4, the prism 33 is a light-transmissive block-shaped member having a reflective surface 33c that is tilted to one side in a longitudinal direction of a rectangular parallelepiped portion. An end surface of one side of the prism 33 in the longitudinal direction is provided with a first diffraction grating 33a, and an end surface of the other side of the prism 33 in the longitudinal direction is provided with a second diffraction grating 33b. The first diffraction grating 33a faces the laser light source 25. The longitudinal direction of the prism 33 is set parallel to the direction of propagation of the light beam. The prism 33 is held by a prism holder 37, and is secured to the upper surface of the slide base 21. The prism holder 37 has a slit 37a for passing the light beam.

The raised mirror 34 for changing the direction of propagation of the light beam by reflecting the incident light beam is disposed opposite to the laser light source 25, with the prism 33 being disposed therebetween. The raised mirror 34 has a reflective surface 34a, which is tilted by an angle of 45 degrees from a reference surface. With the reflective surface 34a being tilted at an angle of 45 degrees and facing the second diffraction grating 33b of the prism 33, the raised mirror 34 is secured to the upper surface of the slide base 21. The center of the reflective surface 34a is formed so as to be substantially aligned with or aligned with the optical axis of the light beam emitted from the laser light source 25. The objective lens 35, which is held by the bi-axial actuator 24, is disposed upwardly of the prism 33.

Accordingly, when a light beam is emitted horizontally from the laser light source 25, the light beam enters the prism 33 from the first diffraction grating 33a, and is split into three beams by the first diffraction grating 33a. The three split light beams pass through the prism 33, and exit from the second diffraction grating 33b at the opposite side. The light beams that have exited from the prism 33 are reflected upward at an angle of 90 degrees by the reflective surface 34a of the raised mirror 34, and pass through the objective lens 35. Here, the light beams are narrowed by the objective lens 35, and are used to irradiate three locations of the information recording surface of the optical disc 36, disposed above the objective lens 35, substantially at points.

The returning light beams reflected by the information recording surface pass through the objective lens 35 again and travel downward, and are reflected by the reflective surface 34a at an angle of 90 degrees. The three light beams reflected by 90 degrees travel horizontally and enter the prism 33 from the second diffraction grating 33b. The light beams that have entered the prism 33 are refracted at predetermined angles by the second diffraction grating 33b and travel towards the reflective surface 33c. The three light beams are reflected by the reflective surface 33c at an angle of 90 degrees, exit from a surface of the prism 33 that is disposed opposite to the reflective surface 33c, and impinge upon the light receiver of the photodetector 26. Based on the state of the three light beams that impinge upon the photodetector 26, an information signal that represents information recorded on the information recording surface and a focus error signal and a tracking error signal for deriving the information signal are read.

In FIG. 2, reference numeral 40 denotes a cover for covering the prism 33 and the prism holder 37. The cover 40 seals in the laser light source 25 and the photodetector 26, and protects them from dirt and dust. In FIGS. 2 and 3, reference numeral 41 denotes a variable resistor, and reference numerals 42 denote chip capacitors. The variable resistor 41 and the chip capacitors 42 are mounted to exposed portions 43 of the electrical circuits disposed at the lower surface of the slide base 21. Reference numeral 44 denotes an FF cable. The laser light source 25 and the other electronic parts, and a focusing coil and a tracking coil of the bi-axial actuator 24, etc., are electrically connected through the FF cable 44.

As shown in FIGS. 1 and 2, the bi-axial actuator 24 comprises an adjuster 54, which is secured to the slide base 21, a supporter 55, which is secured to the adjuster 54, four suspension wires 56, which has one end supported by the supporter 55, a bi-axial movable portion 57, which is resiliently supported by the four suspension wires 56, and two magnets 58, which provide driving force to the bi-axial movable portion 54. The adjuster 54 is movable in the height direction with respect to the slide base 21. The height of the bi-axial actuator 24 can be adjusted by adjusting the amount of protrusion of the adjuster 54 from the upper surface of the slide base 21. The adjuster 54 is secured to the slide base 21 with fixing means such as an adhesive.

The supporter 55 is formed of an insulating material, and is secured to the adjuster 54 by fastening means such as a screw. The supporter 55 comprises a pair of securing portions 55a and 55a that are separated by a predetermined interval in the horizontal direction. Two suspension wires 56 each are secured to the securing portions 55a. The four suspension wires 56 are formed of an electrically conductive material having a suitable resiliency, and are symmetrically disposed parallel to each other in the vertical direction and in the horizontal direction. The bi-axial movable portion 57, which is secured to ends of the four suspension wires 56, includes a lens holder 60 and two sets of coils. The lens holder 60 is formed of an insulating material, and the two sets of coils are mounted to the lens holder 60.

The lens holder 60 is an insulating frame member having securing portions 60a, disposed on respective sides thereof, for securing the suspension wires 56. The objective lens 35 is mounted to the top portion of the lens holder 60. First coils 61 are mounted to one surface of the lens holder 60 and second coils 62 are mounted to the other surface of the lens holder 60, at respective sides where the surfaces intersect the pair of securing portions 60a and 60a of the lens holder 60. The two sets of coils 61 and 62 are a combination of a pair of focusing coils and a pair of tracking coils. Each coil is formed by winding, for example, a very thin copper wire a suitable number of times.

Ends of the four suspension wires 56 are connected to connecting portions of the two sets of coils 61 and 62 using a predetermined connection pattern. A lens-side branch 44a of the FF cable 44 is connected to a fixed side of the four suspension wires 56. By a wiring pattern of the lens-side branch 44a, the two sets of coils 61 and 62 are connected to the terminals 29c at the slide base 21, thereby making it possible to supply electrical current as in the optical device 23.

One magnet 58 is disposed at the outer side of the pair of coils 61 and one magnet 58 of the same type is disposed at the outer side of the pair of coils 62. The magnets 58 have rectangular parallelepiped shapes and have one magnetic pole. For example, the north pole (or the south pole) opposes the front side of the first coils 61, and the opposite pole, that is, the south pole (or the north pole) opposes the front side of the second coils 62. However, obviously, depending upon the specification of the coils, it is possible to use magnets 58 having two magnetic poles and to face the same types of poles toward the coils 61 and the coils 62.

According to the bi-axial actuator 24, it is possible to freely generate thrust in the vertical direction or horizontal direction in the lens holder 60, which has the two sets of coils 61 and 62 secured thereto, in accordance with the electrical current flowing between the four suspension wires 56. As a result, the generation of the thrust causes the bi-axial movable portion 57 including the two sets of coils 61 and 62, the lens holder 60, and the objective lens 35 to move in two directions (focusing direction and tracking direction) that are perpendicular to each other, so that a focusing and/or a tracking operation using light beams that pass through the objective lens 35 is drivingly controlled.

Information signals can be recorded and/or reproduced by using the optical pickup device 20 having the above-described structure in, for example, an optical information recording/reproducing apparatus 70 having the structure shown in FIG. 12. The optical information recording/reproducing apparatus 70 is a specific example of an optical information recording and/or reproducing apparatus, and comprises a chassis 71 (serving as a base), a disc rotating device 72 secured to the chassis 71, the optical pickup device 20 movably supported with respect to the chassis 71, and a pickup moving device 73 for moving the optical pickup device 20 towards and away from the disc rotating device 72.

The chassis 71 is a square frame having a substantially square opening 74. The disc rotating device 72 is mounted to a substantially central portion of a side of the chassis 71. The optical pickup device 20 is disposed in the opening 74, and the pickup moving device 73 for moving the optical pickup device 20 towards and away from the disc rotating device 72 is mounted to the chassis 71.

The disc rotating device 72 chucks the optical disc 36, which is a specific example of a disc, and rotationally drives it at a predetermined velocity (for example, a constant linear velocity), and comprises a spindle motor 75 and a turntable 76. The spindle motor 75 is secured to the upper surface of the chassis 71 with securing means, such as a screw, with its rotating shaft being oriented in the vertical direction. The rotating shaft of the spindle motor 75 is integrally secured to the turntable 76. The turntable 76 comprises a fitting portion 76a, which is removably fitted to a center hole of the optical disc 36, and a placing portion 76b for placing the peripheral edge defining the center hole. The fitting portion 76a has a plurality of engaging pawls which can hold the optical disc 36 by removably engaging the peripheral edge defining the center hole of the optical disc 36.

Various types of optical discs may be used. They include a reproduction-only optical disc having information signals, such as music signals as audio information and image and music signals as video information, previously recorded thereon; a write-once-read-many optical disc on which information signals, such as music signals and image signals, can be recorded only once; and a rewritable optical disc for repeatedly recording information a plurality of times. Discs which may be used in the present invention are not limited to optical discs. Other types of disc-shaped recording media may be used, including a magneto-optical disc for writing information to and reading the information from a thin-film magnetic layer, formed on a surface of a thin disc portion, using an optical head and a magnetic head.

The pickup moving device 73 comprises a feed screw shaft 77 and a guide shaft 78, disposed parallel to each other, a feed motor 80 for rotationally driving the feed screw shaft 77, a mounting bracket 81 to which the feed motor 80 is mounted, a bearing 82 for rotatably supporting one end of the feed screw shaft 77, and a pair of bearings 83 and 83 for supporting respective ends of the guide shaft 78. The feed screw shaft 77 and the guide shaft 78 are disposed on respective sides defining the opening 74 so that the optical pickup device 20 and the disc rotating device 72 are disposed between the feed screw shaft 77 and the guide shaft 78.

The feed screw shaft 77 is connected to the rotating shaft of the feed motor 80, and is integrally rotatable therewith. The feed motor 80, which is connected to one end of the feed screw shaft 77, is secured to the chassis 71 through the mounting bracket 81. The bearing 82, which supports the other end of the feed screw shaft 77, is secured to the chassis 71. Similarly, the pair of bearings 83 and 83, which support the respective ends of the guide shaft 78, are secured to the chassis 71 by securing means, such as screws. In this way, the guide shaft 78, which is supported by the chassis 71, slidably passes through the groove 53a of the auxiliary bearing 53 disposed at the slide base 21 of the optical pickup device 20. The feed screw shaft 77 slidably passes through the hole 52a of the main bearing 52 disposed at the slide base 21.

A power transmitter 85, secured to the slide base 21, engages the feed screw shaft 77. The power transmitter 85 converts rotational motion of the feed screw shaft 77 into linear motion and transmits the linear motion to the slide base 21. The power transmitter 85 comprises (generally two to four) protrusions, formed in correspondence with the width and pitch of the grooves of the feed screw shaft 77, and a plate spring for holding the protrusions so that they can be flexed. With the protrusions being engaged with the grooves of the screw shaft 77, the spring is secured to the slide base 21 with securing means, such as a screw.

Next, a circuit structure for drivingly controlling the optical information recording/reproducing apparatus 70 having the above-described structure will be described. FIG. 13 shows a circuit structure for drivingly controlling the optical information recording/reproducing apparatus 70, and is a block diagram of the circuit structure applied to a recording/reproducing apparatus which can both record (write) information signals onto and reproduce (read) the information signals from an optical disc.

In FIG. 13, reference numeral 90 denotes a system controller for drivingly controlling the rotation of the spindle motor 75 and the feed motor 80. The system controller 90 is connected to a servo circuit 91, which performs a servo controlling operation on the optical pickup device 20, so that signals can be exchanged between it and the servo circuit 91. An operation panel 92 including a power switch and various operation buttons is connected to the system controller 90. A light beam drive detection circuit 93 is connected to the optical pickup device 20. An output from the drive detection circuit 93 is supplied to the system controller 90 and the servo circuit 91. A recording/reproducing circuit 96, which is connected to an input terminal 94 and an output terminal 95, is connected to the drive detection circuit 93.

The recording/reproducing apparatus having the above-described structure records information signals onto and/or reproduces the information signals from the optical disc 36, for example, as follows. By operation of the operation panel 92 by a user, information regarding the operation is input to the system controller 90. Based on the operation information, the system controller 90 outputs a control signal to the spindle motor 75, the feed motor 80, and the servo circuit 91.

When the system controller 90 supplies the control signal to the spindle motor 75, the spindle motor 75 is, for example, rotationally driven at a constant linear speed. By the control signal from the system controller 90, the feed motor 80 is driven, causing the optical pickup device 20 to move so that a desired location of the information recording surface of the optical disc 36 is irradiated with a light beam. The control signal is supplied to the servo circuit 91.

For example, an information signal is supplied from the input terminal 94 to the light beam drive detection circuit 93 through the recording/reproducing circuit 96. By controlling the light beam output from the optical pickup device 20 in accordance with the signal from the drive detection circuit 93, the information signal from the input terminal is recorded onto the information recording surface of the optical disc 36. The drive detection circuit 93 detects an information signal previously recorded on the information recording surface of the optical disc 36, and the detected information signal is output from the outer terminal 95 through the recording/reproducing circuit 96.

Along with this, the drive detection circuit 93 detects a light beam tracking error signal and focusing error signal, and supplies these error signals to the servo circuit 91. This causes a control signal to be supplied from the servo circuit 91 to the optical pickup device 20, so that the aforementioned bi-axial actuator 24 performs a tracking and/or focusing control operation. By supplying the operation signal from the operation panel 92 to the system controller 90, controlling operations such as moving the optical pickup device 20 to a desired recording or reproduction position are performed. By irradiating the information recording surface of the optical disc 36 with the light beam from the optical pickup device 20 including the bi-axial actuator 24, an information signal is recorded and/or reproduced.

The present invention is not limited to the above-described embodiments. Although, in the embodiments, an optical disc is used as an information recording medium, other disc-shaped recording media, such as a magneto-optical disc for recording and/or reproducing information using an optical head and a magnetic head at the same time, may be used. In addition, although in the embodiment, a disc recording/reproducing apparatus which can both record and reproduce information is used as an optical information recording and/or reproducing apparatus, a disc recording apparatus which can only record information or a disc reproducing apparatus which can only reproduce information may obviously be used.

Although, in the embodiments, a bi-axial actuator is used as an objective lens drive device, with a wire supporting method being used as a specific example, the present invention is not limited thereto. Various other types of bi-axial actuators may obviously be used, including a plate spring type in which a movable portion is supported by a plate spring, a hinge type in which a movable portion is supported by a hinge mechanism, and a shaft sliding type in which an objective lens is moved sideways by rotating a movable portion with a shaft as a center. In addition, other types of objective lens drive devices may be used. Accordingly, various modifications may be made in the present invention without departing from the gist of the present invention.

As described above, in the optical pickup device of the application comprising an objective lens drive device and a slide base, the slide base includes a circuit core, an external frame, and an external base portion, and the circuit core and the external frame have positioning holes with respect to a die. Therefore, by fitting the at least two pins at the die to the at least two positioning holes of the circuit core and the external frame, it is possible to position the circuit core in the die, so that, with the circuit core being positioned in the die, the external base portion can be insert molded and integrally formed with the circuit core. By this, it is possible to prevent positional displacement and flexing of the circuit core caused by the flow of synthetic resin, to stably secure the wires of the electrical circuits at predetermined positions in the slide base, and to form the circuit core in the slide base with a required high dimensional precision. In addition, since the circuit core functioning as an electrical wiring is integrally formed with the external base portion, it is possible to reduce the number of and frequency of use of wiring parts, such as an FF cable and a connector, so that the number of mounting operations and costs can be reduced.

In the optical pickup device of the application, the external base portion has openings, and a connecting portion of the circuit core that should not be connected and a portion of the circuit core that should be separated are cut after injection molding. Therefore, it is possible to prevent partial flexing and deformation of the circuit core during the injection molding, to maintaining the fine wiring shape in the slide base in a predetermined shape, to increase yield during the injection molding of the circuit core, and to enhance workability.

In the optical pickup device of the application, the openings of the external base portion are formed by the supporting pins at the die. Therefore, it is easy to form the openings for cutting the connecting portion of the circuit core that needs to be cut and the portion of the circuit core that needs to be separated, and to prevent the structure of the die for forming the openings from becoming complicated.

In the optical pickup device of the application, steps are formed at the circuit core in the height direction. Therefore, by mounting electronic parts to the steps, it is possible to three-dimensionally dispose the desired electronic parts at different heights, and, thus, to dispose the electrical circuits at different heights.

In the optical information recording and/or reproducing apparatus of the application comprising a disc rotating device and an optical pickup device, the optical pickup device comprises an objective lens drive device and a slide base. The slide base includes a circuit core, an external frame, and an external base portion, and the circuit core and the external frame have positioning holes. Therefore, it is possible to provide a small, light optical information recording and/or reproducing apparatus using the optical pickup device in which, by fitting the at least two pins at the die to the at least two positioning holes of the circuit core and the external frame, it is possible to position the circuit core in the die, so that, with the circuit core being positioned in the die, the external base portion can be insert molded and integrally formed with the circuit core. By this, it is possible to prevent positional displacement and flexing of the circuit core caused by the flow of synthetic resin, to stably secure the wires of the electrical circuits at predetermined positions in the slide base, and to form the circuit core in the slide base with a required high dimensional precision. In addition, since the optical pickup device is small and light, the optical pickup device can be drivingly controlled with high precision, and the number of and frequency of use of the wiring parts, such as an FF cable and a connector, can be reduced, so that the number of mounting operations and costs can be reduced.

What is claimed is:

1. An optical pickup device comprising:
an objective lens drive device including an objective lens opposing an information recording surface of a disc-shaped recording medium; and
a slide base for mounting an optical device for irradiating the information recording surface with a light beam in order to read and/or write an information signal, the slide base moving substantially parallel to the information recording surface and comprising a circuit core and an external base portion,
wherein the circuit core is an electrical conductor forming an electrical circuit for supplying electricity to the objective lens drive device,
wherein the external base portion is an insulating member for covering a surface of the circuit core with a portion of the circuit core being exposed,
wherein an external frame is continuously formed with the outer side of the circuit core and is cut off from the circuit core after covering the circuit core with the external base portion by injection molding, and
wherein the external frame has at least two positioning holes for positioning the external frame at a die, used for the injection molding, when covering the circuit core, and
wherein, with the circuit core and the external frame being positioned at the die by fitting at least two positioning pins disposed at the die to the at least two positioning holes of the external frame, the external base portion is molded integrally with the circuit core by the injection molding.

2. An optical pickup device according to claim 1, wherein, during the injection molding, the circuit core includes, as an electrical circuit, a connecting portion that is not required and a connecting portion that needs to be separated, wherein the external base portion has an opening for exposing the connecting portions, and wherein the connecting portions are cut using the opening after the injection molding.

3. An optical pickup device according to claim 2, wherein the opening is formed by a supporting pin disposed at the die and used to support the connecting portions.

4. An optical pickup device according to claim 1, wherein electronic parts, including a condenser, a resistor, and a laser light source, are mountable to the portion of the circuit core that is exposed at the external base portion of the slide base.

5. An optical pickup device according to claim 4, wherein the circuit core comprises a step in the height direction for allowing the electronic parts to be mounted at different heights.

6. An optical pickup device comprising:
an objective lens drive device including an objective lens opposing an information recording surface of a disc-shaped recording medium; and
a slide base for mounting an optical device for irradiating the information recording surface with a light beam in order to read and/or write an information signal, the slide base moving substantially parallel to the information recording surface and comprising a circuit core and an external base portion,
wherein the circuit core is an electrical conductor forming an electrical circuit for supplying electricity to the objective lens drive device,
wherein the external base portion is an insulating member for covering a surface of the circuit core with a portion of the circuit core being exposed, and
wherein, during injection molding, the circuit core includes, as an electrical circuit, a connecting portion that is not required and a connecting portion that needs to be separated, wherein the external base portion has an opening for exposing the connecting portions, and wherein the connecting portions are cut using the opening after the injection molding.

7. An optical pickup device according to claim 6, wherein the opening is formed by a supporting pin disposed at the die and used to support the connecting portions.

8. An optical pickup device according to claim 6, wherein electronic parts, including a condenser, a resistor, and a laser light source, are mountable to the portion of the circuit core that is exposed at the external base portion of the slide base.

9. An optical pickup device according to claim 8, wherein the circuit core comprises a step in the height direction for allowing the electronic parts to be mounted at different heights.

10. An optical information recording and/or reproducing apparatus comprising:
a disc rotating device for rotationally driving a disc-shaped recording medium; and
an optical pickup device for recording an information signal onto and/or reproducing the information signal from an information recording surface of the disc-shaped recording medium,
wherein the optical pickup device comprises:
an objective lens drive device including an objective lens opposing the information recording surface; and
a slide base for mounting an optical device for irradiating the information recording surface with a light beam in order to read and/or write an information signal, the slide base moving substantially parallel to the information recording surface and comprising a circuit core and an external base portion,
wherein the circuit core is an electrical conductor forming an electrical circuit for supplying electricity to the objective lens drive device,
wherein the external base portion is an insulating member for covering a surface of the circuit core with a portion of the circuit core being exposed,
wherein an external frame is continuously formed with the outer side of the circuit core and is cut off from the circuit core after covering the circuit core with the external base portion by injection molding,
wherein the external frame has at least two positioning holes for positioning the external frame at a die, used for the injection molding, when covering the circuit core, and
wherein, with the circuit core and the external frame being positioned at the die by fitting at least two positioning pins disposed at the die to the at least two positioning holes of the external frame, the external base portion is molded integrally with the circuit core by the injection molding.

11. An optical information recording and/or reproducing apparatus comprising:
a disc rotating device for rotationally driving a disc-shaped recording medium; and
an optical pickup device for recording an information signal onto and/or reproducing the information signal from an information recording surface of the disc-shaped recording medium,
wherein the optical pickup device comprises:
an objective lens drive device including an objective lens opposing the information recording surface; and
a slide base for mounting an optical device for irradiating the information recording surface with a light beam in order to read and/or write an information signal, the slide base moving substantially parallel to the information recording surface and comprising a circuit core and an external base portion,
wherein the circuit core is an electrical conductor forming an electrical circuit for supplying electricity to the objective lens drive device,
wherein the external base portion is an insulating member for covering a surface of the circuit core with a portion of the circuit core being exposed, and
wherein, during injection molding, the circuit core includes, as an electrical circuit, a connecting portion that is not required and a connecting portion that needs to be separated, wherein the external base portion has an opening for exposing the connecting portions, and wherein the connecting portions are cut using the opening after the injection molding.
